(19) United States
(12) Patent Application Publication
(10) Pub. No.: US 2015/0154611 A1
(43) Pub. Date: Jun. 4, 2015

(54) DETECTING POTENTIALLY FALSE BUSINESS LISTINGS BASED ON GOVERNMENT ZONING INFORMATION

(71) Applicant: Melanie L. Donny-Clark, Jersey City, NJ (US)

(72) Inventor: Melanie L. Donny-Clark, Jersey City, NJ (US)

(73) Assignee: GOOGLE INC., Mountain View, CA (US)

(21) Appl. No.: 13/343,983

(22) Filed: Jan. 5, 2012

(51) Int. Cl. G06Q 30/00; G06Q 99/00

(52) U.S. Cl. CPC G06Q 30/0185

(57) ABSTRACT

An apparatus for detecting potentially false business listings is provided. The apparatus may include a memory that stores government zoning information and mappings between the government zoning information and specified business types. The apparatus may also include a processor operative to receive a request to verify whether a business listing is a potentially false business listing. The apparatus may compare the business type of the business listing with the government zoning information by leveraging one or more of the stored mappings. Based on this comparison, the processor may identify potentially false business listings in the plurality of business listings. Even further, depending on the similarity between the business type from the business listing and the compared government zoning information, the apparatus may request moderation of the business listing so that the business listing is not erroneously identified as a potentially false business listing.

### BACKGROUND

When a user desires to find a business, such as a plumbing service, a law firm, a doctor, or other such business, the user may turn to the Internet to conduct an online search for the business. In many instances, the user may know what type of business to search for, but may not have a particular business in mind.

To conduct an online search for the business type, the user may turn to an online search provider that has previously aggregated business listings for various businesses. After sending a business search query to the online search provider, the user may receive a number of search results, which may be presented in a search result webpage or the like. The search result web page may include one or more business listings, which may list the name, postal address, and contact information for the business, or other such business information.

Because an online search provider is able to present many different businesses at once to a user, there may be a high degree of competition among businesses for user attention. Since users typically seek out businesses that are geographically close, a business may provide a false address to the online search provider so that its business listing is provided to a user searching for that type of business in the user's local area, even though the business is not actually located in the user's local area. The false address listing may entice the user into contacting the business and thereby may lead the user away from choosing a business that is geographically closer to him or her. An online search provider has an interest in providing accurate business listings to its users, and preventing these types of misleading business listings.

### BRIEF SUMMARY

In one embodiment, an apparatus for detecting potentially false business listings is disclosed. The apparatus may include a processor operative to receive business listing information, including information from which a business location and a business type can be determined and, access, from a computer-readable medium, government zoning information pertaining to a zoning area that includes the business location, including information identifying one or more business types that are permitted in the zoning area. The processor may be further operative to compare the business type of the business listing with the one or more business types that are permitted in the zoning area, and identify a business listing as a potentially false business listing when the business type of the business listing does not match any of the one or more business types that are permitted in the zoning area.

In another embodiment of the apparatus, the processor is further operative to flag the potentially false business listing so that it is not made publicly available.

In a further embodiment of the apparatus, the processor is further operative to remove the potentially false business listing from a data repository containing one or more business listings.

In yet another embodiment of the apparatus, processor is further operative to request moderation of the potentially false business listing to confirm whether the potentially false business listing should be made publicly available.

In yet a further embodiment of the apparatus, the processor is further operative to receive the business listing information with a request to verify whether the business listing is a potentially false business listing prior to publication of the business listing.

In another embodiment of the apparatus, the processor is further operative to receive the business listing information with a request to verify whether the business listing is a potentially false business listing after a change has been made to the business listing.

A method for detecting potentially false business listings is also disclosed. In one embodiment, the method includes receiving business listing information, including information from which a business location and a business type can be determined, and accessing with a processor, from a computer-readable medium, government zoning information pertaining to a zoning area that includes the business location, including information identifying one or more business types that are permitted in the zoning area. The method may also include comparing the business type of the business listing with the one or more business types that are permitted in the zoning area, and identifying a business listing as a potentially false business listing when the business type of the business listing information does not match any of the one or more business types that are permitted in the zoning area.

In another embodiment of the method, the method may include flagging the potentially false business listing so that it is not made publicly available.

In a further embodiment of the method, the method may include removing the potentially false business listing from a data repository containing one or more business listings.

In yet another embodiment of the method, the method may include requesting moderation of the potentially false business listing to confirm whether the potentially false business listing should be made publicly available.

In yet a further embodiment of the method, the business listing is received with a request to verify whether the business listing is a potentially false business listing prior to publication of the business listing.

In another embodiment of the method, the business listing is received with a request to verify whether the business listing is a potentially false business listing after a change has been made to the business listing.

A computer-readable medium is also disclosed. In one embodiment, the computer-readable medium may have instructions stored thereon that, when executed by a processor, cause the processor to perform a method. The method may include receiving business listing information, including information from which a business location and a business type can be determined, and accessing with the processor, from the computer-readable medium, government zoning information pertaining to a zoning area that includes the business location, including information identifying one or more business types that are permitted in the zoning area. The method may also include comparing the business type of the business listing with the one or more business types that are permitted in the zoning area, and identifying a business listing as a potentially false business listing when the business type of the business listing information does not match any of the one or more business types that are permitted in the zoning area.

In another embodiment of the computer-readable medium, the method may include flagging the potentially false business listing so that it is not made publicly available.

In a further embodiment of the computer-readable medium, the method may include removing the potentially false business listing from a data repository containing one or more business listings.

In yet another embodiment of the computer-readable medium, the method may include requesting moderation of the potentially false business listing to confirm whether the potentially false business listing should be made publicly available.

In yet a further embodiment of the computer-readable medium, the business listing is received with a request to verify whether the business listing is a potentially false business listing prior to publication of the business listing.

In another embodiment of the computer-readable medium, the business listing is received with a request to verify whether the business listing is a potentially false business listing after a change has been made to the business listing.

### BRIEF DESCRIPTION OF THE DRAWINGS

FIG. 1 illustrates one example of an apparatus for detecting potentially false business listings according to aspects of the disclosure.

FIG. 2 illustrates one example of a business listing server according to aspects of the disclosure.

FIG. 3 illustrates one example of a zoning verification server according to aspects of the disclosure.

FIGS. 4A-4D illustrate an example of verifying one or more business listings based on government zoning information according to aspects of the disclosure.

FIGS. 5A-5B illustrate one example of logic flow for detecting potentially false business listings based on government zoning information according to aspects of the disclosure.

### DETAILED DESCRIPTION

The present disclosure relates to a system and method for detecting potentially false business listings based on government zoning information. In particular, government zoning information is gathered and one or more business listing attributes are compared with the government zoning information to detect potentially false business listings. This provides a mechanism to decrease the likelihood that a given business listing is a false business listing.

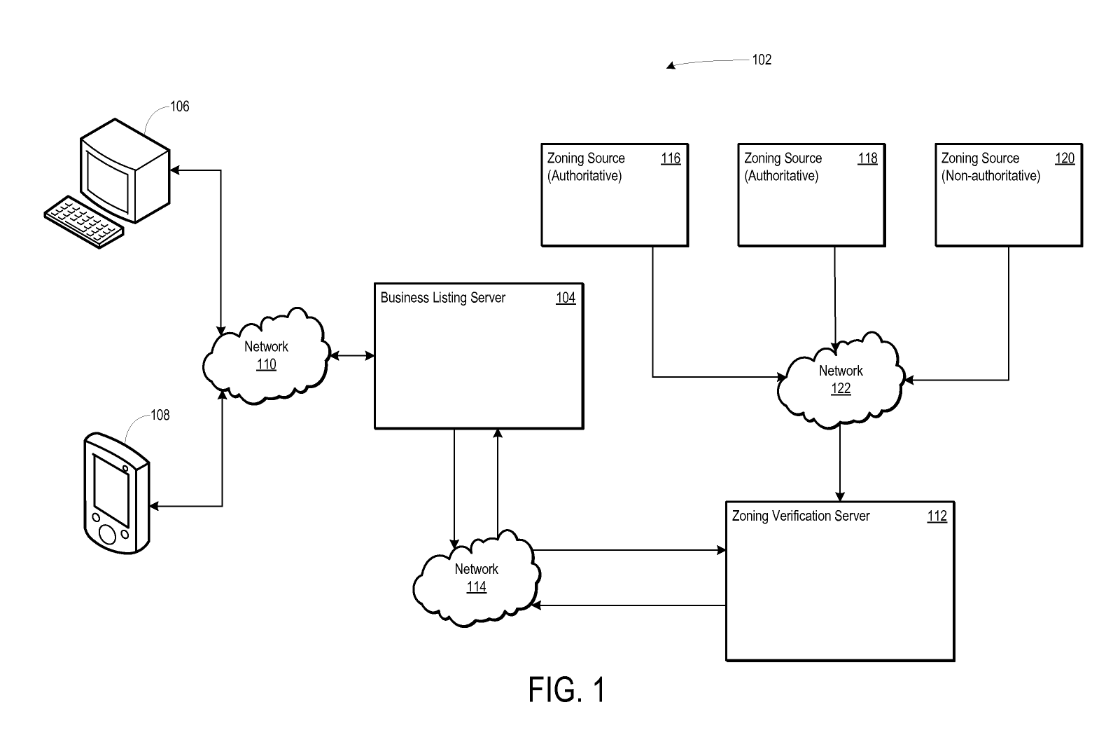

FIG. 1 illustrates one example of an apparatus 102 for detecting potentially false business listings. In one embodiment, the apparatus 102 may include a business listing server 104 in communication with client devices 106-108 via a network 110. The apparatus 102 may also include a zoning verification server 112 in communication with the business listing server 104 via a network 114. The zoning verification server 112 may be in communication with one or more sources 116-120 of government zoning information via a network 122.

The business listing server 104 is operative to facilitate the creation, storage and provision of one or more business listings. In general, a business listing describes information about a business. A business listing may include may different types of information about the business, such as its title (e.g., corporate business name (“Acme, Inc.”), informal name (“Acme”), etc.), phone number, a Uniform Resource Location (“URL”) for its website or homepage, a description, or any other type of information about the business. Each of the types of information may be considered a business listing attribute, and each attribute may have a value. For example, the informal business name may be considered a business listing attribute and the business name “Acme” may be considered the value for that business listing attribute.

In one embodiment, a business owner may establish a business listing account on the business listing server 104 using one or more of the client devices 106-108 in communication with the business listing server 104. For example, the business listing server 104 may be running a software application that includes a Hypertext Protocol (“HTTP”) interface, or other similar interface, for interacting with the business listing server 104. One or more client devices 106 may interact with the business listing server 104 using an HTTP-enabled software application, such as Internet browser like Google Chrome.

In another embodiment, the business listing server 104 may establish a business listing for a business based on aggregated business information, such as information obtained from other online service providers, and a user may take ownership of the established business listing after being authenticated as the owner of the business associated with the established business listing. In this embodiment, the business listing server 104 may request that the user authenticate the ownership of the business using one or more authentication techniques, such as photographs, providing a phone number at which the business listing server 104 may contact the owner of the business, a mailing address for contacting the owner of the business, or other such authentication schemes.

In an alternative embodiment, the business listing server 104 may also include, be in communication with, or receive information from an Internet search provider that provides one or more business listings to one or more end users, such as users using client devices 106-108. Moreover, the business listing server 104 may include or receive information from different types of service providers for providing business information to one or more end users, such as a map service provider, a local search provider, a social network provider, or any other type of service provider.

The client devices 106-108 in communication with the business listing server 104 may be any type of client device. In one embodiment, the client devices 106-108 may include a desktop computer 106 in use by a user to conduct Internet searches using the business listing server 104. The desktop computer 106 may transmit one or more search queries to the business listing server 104 and, in response, the business listing server 104 may include one or more business listings in the search results sent to the desktop computer 106. The business listing information provided to the desktop computer 106 may include one or more URLs for one or more websites associated with the business listings provided to the desktop computer 106. The user may select one or more of the URLs to visit the websites associated with the business listings. A website URL for a business listing is one of many different types of business listing information that the business listing server 104 may provide. For example, the business listing provided to the user may also include the formal business' name, an informal business name, a phone number of the business, a mailing address for the business, hours of operation for the business, or any other such business information.

In addition to a desktop computer 106, the client devices 106-108 may include a mobile device 108, such as a laptop, a smartphone, a Personal Display Assistant (“PDA”), a tablet computer, netbook, or other such mobile device. As with the desktop computer 106, the mobile device 108 may transmit one or more queries to the business listing server 104, such as search queries or navigation queries, and the business listing server 104 may incorporate one or more business listings in the response sent to the mobile device 110. Accordingly, regardless of whether the client device 106-108 are desktop computers 106, mobile devices 108 (e.g., laptops, smartphones, PDAs, etc.), or any other such client device, the business listing server 104 may be operative to provide one or more business listings to the client devices 106-108 based on a search request for a business or other request for the one or more business listings.

The business listing server 104 may also be in communication with a zoning verification server 112. The zoning verification server 112 is operative to verify and/or determine the government land use zone(s) for a location associated with a given business listing. Although shown as separate systems, the business listing server 104 and the zoning verification server 112 may actually be part of a single system.

The zoning verification server 112 may also verify and/or determine whether a business associated with a corresponding business listing is of a type expected to be located at the geographic location provided in the business listing. The zoning verification server 112 may receive values for one or more business listing attributes for a business listing from the business listing server 104, and use those values to determine the government land use zone corresponding to the business listing and/or to verify that the business is of a type that is permitted to be located in the land use zone corresponding to the business listing. In one embodiment, the zoning verification server 112 may receive a postal address and a business type for a business listing from the business listing server 104, and may transmit a corresponding government land use zone back to the business listing server 104.

In another example, the zoning verification server 112 may receive a postal address and a business type for a corresponding business listing and, in response, may transmit an indication of whether the business listing is of a type expected for the given postal address. In this example, the indication may include a request to remove the business listing from the business listing server 104, or may include a notification that the business listing should be moderated or reviewed by the operator of the business listing server 104.

In yet another example, the zoning verification server 112 may receive a postal address and business listing attribute values, other than a business type, for a business listing. For example, it may be that the business listing does not have an assigned business type. In this embodiment, the zoning verification server 112 may rely on additional sources of information, such as an online search provider or an internal database of business names, to determine the business type of the business listing. After determining the business type of the business listing and whether it corresponds to the provided postal address, the zoning verification server 112 may then transmit to the business listing server 104 an indication of whether the business listing should be removed, reviewed or moderated.

The zoning verification server 112 may perform its verification and/or determination by leveraging sources 116-120 of government zoning information. The sources 116-120 of government zoning information are operative to provide zoning information for a geographic area to the zoning verification server 112. Examples of government zoning information include Euclidean zoning codes, performance zoning criteria, incentive zoning criteria, form-based zoning codes, any other zoning techniques and/or codes now known or later developed, or combinations thereof.

The sources 116-120 of government zoning information may include authoritative and non-authoritative sources of government zoning information. An example of an authoritative source of government zoning information may be a website sponsored by a government entity. An example of a non-authoritative source of government zoning information may be a website sponsored or maintained by a commercial entity that may act as an intermediary between the zoning verification server 112 and an authoritative source of government zoning information. Alternatively, an authoritative source of government zoning information may be a source considered to be trustworthy or considered as a primary source of government zoning information, whereas a non-authoritative source may be a secondary source of such zoning information.

The government zoning information may be retrieved as any type of information. For example, the government zoning information may be stored by a source 116 as an image of a map of a geographic area with portions of the map designated with one or more zoning codes. In this example, the zoning verification server 112 may be operative to deconstruct the image of the map to discern or identify a government zone applied to a particular portion of the map. In another example, the government zoning information may be stored as text, where the text includes alphanumeric characters that associate a government zoning code with a particular geographic area. In this example, the zoning verification server 112 may be operative to identify that the government zoning information is stored as text and may be operative to parse the text to identify the government zoning code associated with the particular geographic area.

In the alternative, the zoning verification server 112 may be configured with instructions for parsing government zoning information retrieved from a particular source. For example, where the source 116 stores government zoning information as text, the zoning verification server 112 may be configured to parse the government zoning information as text. As another example, where the source 118 stores government zoning information as images, the zoning verification server 112 may be configured to parse the images retrieved from the source 118.

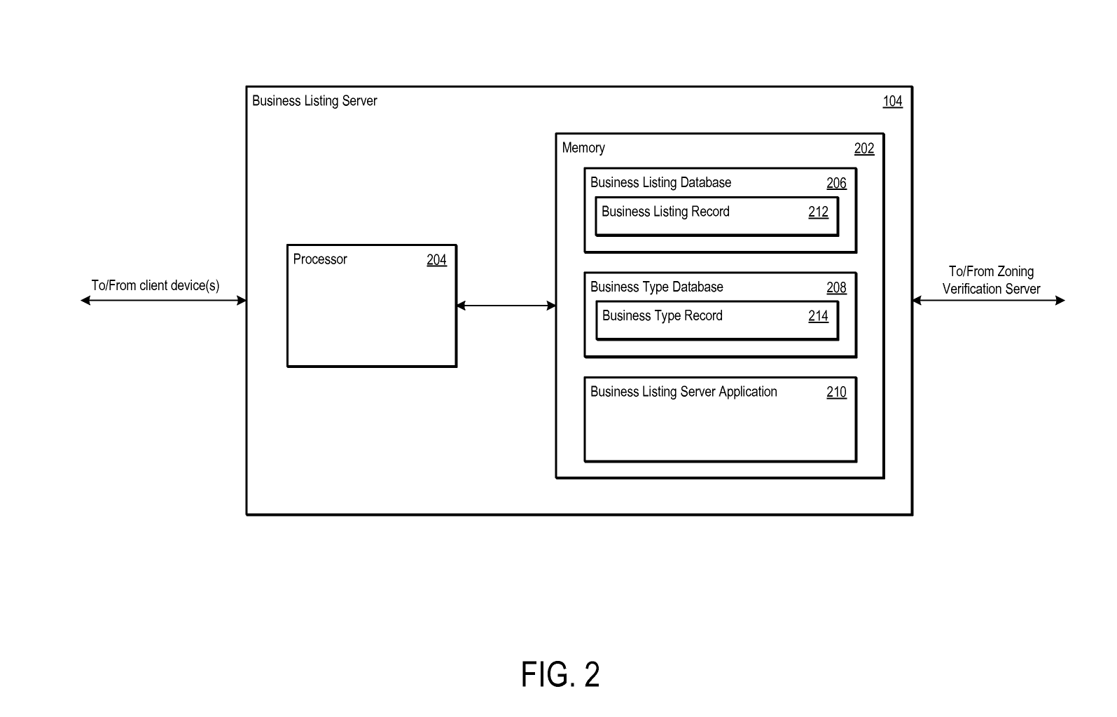

FIG. 2 is one example of the business listing server 104. The business listing server 104 may include a memory 202 in communication with a processor 204. The memory 202 may be operative to store a business listing database 206, a business type database 208, and a business listing server application 210. Although FIG. 2 shows that the business listing server 104 is distinct from the zoning verification server 112, the business listing server 104 and the zoning verification server 112 may operate within the same housing and share one or more computing resources, such as processor, memories, input interfaces, output interfaces, or other such computing resources. Moreover, the memory 202 and the processor 204 may be respectively distributed over a plurality of memories and a plurality of processors.

The business listing database 206 may store one or more business listing records 212. A business listing record 212 may store one or more values for various business listing attributes, such as a business title, phone number, type, description, postal address, URL for the business' website, or other such business information and/or business listing attributes.

The business type database 208 may store one or more business type records 214, where each business type record 214 may associate a particular business type with a zoning classification such as “light commercial,” “heavy commercial,” “residentially commercial,” “light industrial,” or other such zoning classifications.

The business type database 208 may be leveraged by the business listing server 104 when a user or the business listing server 104 adds or modifies a business listing. In one embodiment, when a user adds a business listing to the business listing server 104 via the business listing server application 210, the user may be given an option to assign a business type, selected from the business type database 208, to the newly created business listing. Similarly, a user may modify a business listing in the business listing database 206 by adding a business type selected from the business type database 208 or by removing a business type previously assigned to the business listing. It should be understood that the user may modify the business listing in other ways as well, e.g., modifying the business' name, hours of operations, or any other type of modification to the business listing.

In another embodiment, the business listing server 104 may automatically assign a business type selected from the business type database 208 to a business listing. For example, when the business listing server 104 receives business information regarding a business from a third-party source, namely, a source other than the business owner, the business listing server 104 may automatically assign a business type to that business. Examples of third-party sources include aggregation websites, phonebook listings (online or offline), yellow pages directories, a website for the business, or any other such third-party source or combinations thereof.

The assignment of the business type to the business listing may be based on any number of factors including, but not limited to, the business' name, location, hours of operation, size, popularity, or any other such factors or combinations thereof. The owner of the business may later contact the business listing server 104, via the business listing server application 210, to gain control of the business listing created by the business listing server 104. The business listing server 104 may also verify the accuracy of the business listing information gained from the third-party sources, such as by contacting the owner of the business where such information is available. In either embodiment (or combinations thereof), the business listing server 104 may leverage the business type database 208 to establish a business type for the business listing.

The business listing server application 210 is operative to facilitate interactions between users and the business listing server 104. For example, when executed by the processor 204, the business listing server application 210 may establish an interface, such as a website, for interacting with the business listing server 104. Where the business listing server application 210 establishes a website for interacting with the business listing server 104, a user, such as a business owner, may establish or modify a business listing stored in the business listing database 206. In addition, the business listing server application 210 may facilitate the communication of the business listing server 104 with one or more other online service providers, such as an online search engine, a social network provider, or other such online service providers. Where the online service provider is an online search engine, the business listing server application 210 may be operative to deliver one or more business listings stored in the business listing database 206 based on a search query received from (or transmitted by) the online search provider.

The business listing server application 210 may also be operative to facilitate communications between the business listing server 104 and the zoning verification server 112. For example, the business listing server application 210 may be operative to transmit one or more business listings and/or business listing information to the zoning verification server 112 for verifying whether a business of the type provided in the business listing is expected or permitted to be located at the address provided in the business listing. The business listing server application 210 may also determine whether a business of the type provided in the business listing is expected or permitted to be located at the provided address based on a response received from the zoning verification server 112. Interaction details between the business listing server 104 and the zoning verification server 112 are discussed further below.

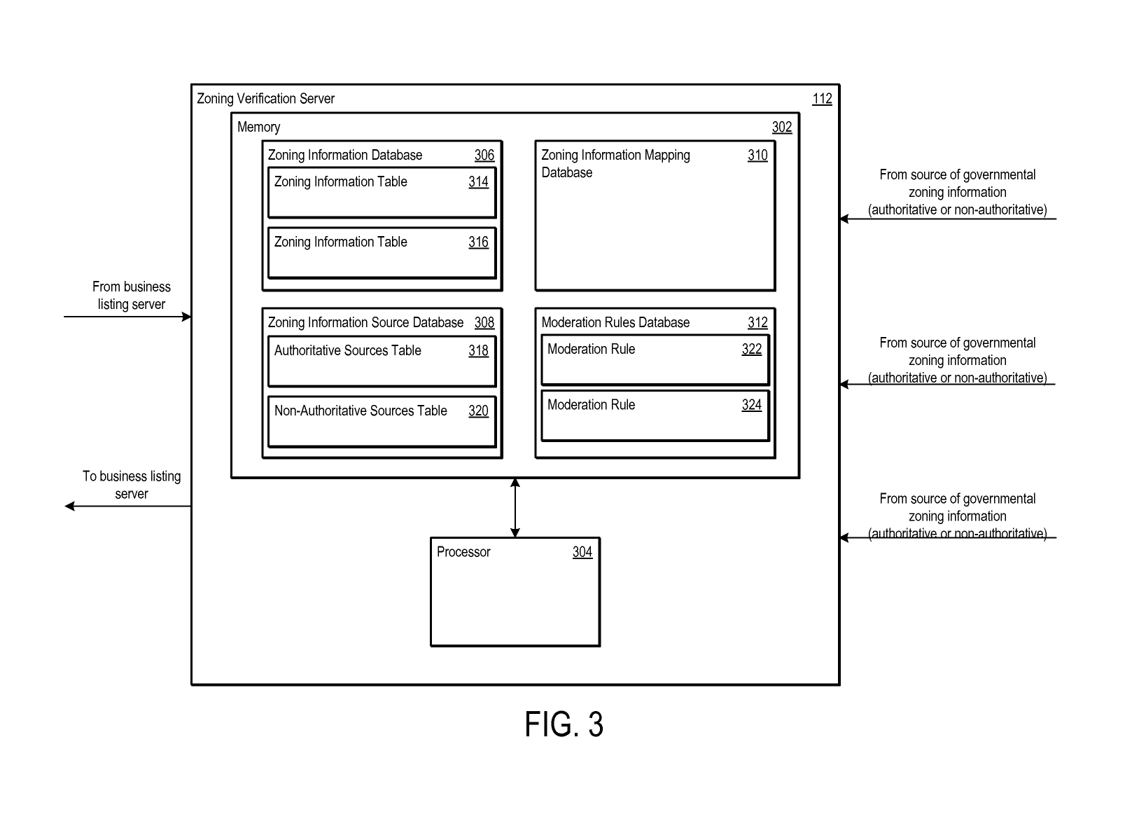

FIG. 3 illustrates one example of the zoning verification server 112 according to aspects of the disclosure. In one embodiment, the zoning verification server 112 may include a memory 302 and a processor 304. As discussed previously, the zoning verification server 112 and the business listing server 104 may share one or more of the computing resources, such as the memories and/or the processors. Although shown in different figures, the memory 202 of FIG. 2 may be the same memory as the memory 302 of FIG. 3, and the processor 204 of FIG. 2 may be the same processor as the processor 304 of FIG. 3. Combinations of the foregoing are also possible. Moreover, the functionality attributed to memory 302 and processor 304 may be distributed over a plurality of memories and/or a plurality of processors.

The zoning verification server 112 may include one or more databases that can be used to determine whether a business listing is a potentially false business listing. In one embodiment, the zoning verification server 112 may include a zoning information database 306, a zoning information source database 308, a zoning information mapping database 310, and a moderation rules database 312. In alternative embodiments, the zoning verification server 112 may include alternative arrangements of the foregoing databases 306-312. For example, the information contained within the databases can be contained within a single database, or dispersed among even more databases.

The zoning information database 306 may contain government zoning information from one or more of the government zoning information sources 116-120. The government zoning information may include Euclidean zoning codes, performance zoning criteria, incentive zoning criteria, form-based zoning codes, or any other zoning technique and/or codes now known or later developed, or combinations thereof. The government zoning information may indicate how various tracts of land in a geographic area have been zoned for land use according to a governmental authority. As discussed below, the zoning verification server 112 may account for regional differences in the government zoning information received through the use of one or more zoning information tables 314-316 and a zoning information mapping database 310.

The government zoning information from the government zoning information sources 116-120 may be passively or actively transmitted to the zoning verification server 112. In a passive scenario, the zoning verification server 112 may periodically query a government zoning information source for government zoning information. For example, the zoning verification server 112 may query the source semi-annually, annually, weekly, or at any other predetermined period of time. In an active scenario, the government zoning information sources 116-120 may transmit the government zoning information to the zoning verification server 112 without prompting by the zoning verification server 112. For example, the government zoning information sources 116-120 may transmit their respective government zoning information to the zoning verification server 112 at predetermined periods of time, such as annually, semi-annually, monthly, or at any other periods of time.

Moreover, a combination of a passive and active scenario is also possible. For example, the government zoning information sources 116-120 may be configured to transmit government zoning information to the zoning verification server 112 at a predetermined date, such as January 1 of every new year (e.g., annually). However, the zoning verification server 112 may be further configured to query the government zoning information sources 116-120 after a predetermined period of time has elapsed from the expected transmission date. For example, the zoning verification server 112 may be configured to query the government zoning information sources 116-120 five days after the expected date of transmission. Thus, using the January 1 example above, when the zoning verification server 112 does not receive the government zoning information from the government zoning information sources 116-120 by January 6, the zoning verification server 112 may transmit a query to the government zoning information sources 116-120 for the government zoning information.

The zoning information database 306 may be configured to account for regional differences in the government zoning information received from the government zoning information sources 116-120. For example, the government zoning information received from one state (e.g., New Jersey) may be different from the government zoning information received from a second state (e.g., New York). Thus, the zoning information database 306 may be segmented into one or more zoning information tables 314-316 that segment the government zoning information according to geographical area. Of course, other segmentation or organization schemes are also possible, such as a separate table for each state, for each ZIP code in a state, for each city in each state, and so forth. In summary, the zoning information database 306 may include the aggregation of the government zoning information received from the various government zoning information sources 116-120.

The zoning verification server 112 may also receive the government zoning information from various types of sources of government zoning information. For example, the zoning verification server 112 may receive the government zoning information from both authoritative sources and non-authoritative sources. Examples of authoritative sources include local government sources (e.g., city or county sources), state government sources, federal government sources, or other such authoritative sources. Examples of non-authoritative sources include commercial entities, non-profit organizations, aggregation websites that retrieve their information from authoritative sources, and other non-authoritative sources. In one embodiment, a non-authoritative source may become an authoritative source after the non-authoritative source has sufficiently established that the government zoning information is trustworthy or comparable to the government zoning information provided by an authoritative source.

To manage the authoritative sources and non-authoritative sources, the zoning verification server 112 may include an authoritative sources table 318 and a non-authoritative sources table 320 in the zoning information source database 308. The authoritative sources table 318 may include one or more records identifying an authoritative source of government zoning information. Similarly, the non-authoritative sources table 320 may include one or more records identifying a non-authoritative source of government zoning information. Examples of information that may be stored in the records of either the authoritative sources table 318 or the non-authoritative sources table 320 include the name of the source, a mailing address for the source, a URL for the source, the predetermined time period for when the source is expected to provide government zoning information, the predetermined time period for when the zoning verification server 112 is to retrieve government zoning information from the source, whether the source is an active or passive source, and other such information.

The zoning verification server 112 may also account for regional differences in the zoning schemes provided by the various government zoning information sources 116-120, and how those zoning schemes relate to business types. For example, the state of New Jersey may not use the same Euclidean zoning codes as the state of New York. Similarly, the city of Newark, N.J. may not use the same Euclidean zoning codes as the city of Trenton, N.J. Thus, the zoning verification server 112 may maintain a master list of business types, and may map the zoning codes used by a given locality to one or more of the business types in the master list. For example, should a particular locality use a zoning code of “LC” to indicate “light commercial,” the zoning verification server 112 may establish a mapping between “LC” and a business type (e.g., a law firm) that is associated with the “light commercial” zoning code in the master list of business types.

Further still, the mappings in the zoning information mapping database 310 may map one or more zoning codes to one or more business types. For example, the zoning verification server 112 may map a “light commercial” zoning code and a “heavy commercial” zoning code to a single, business type, such as “supermarket.” As another example, the zoning verification server 112 may map a “light commercial” zoning code to the “supermarket” business type, a “law firm” business type, and an “electronics retailer” business type.

Moreover, the zoning mapping database 310 may include mappings to indicate that no businesses should be located at a location having a given zoning code. For example, the zoning information mapping database 310 may include zoning codes (e.g., for state parks, nature preserves, recreational areas, or other such zoning codes) and those zoning codes may not be mapped to any business types, indicating that no businesses are permitted within areas designated with those zoning codes.

In sum, the zoning information mapping database 310 may map all possible zoning codes to all possible business types assignable by the business listing server 104. In this fashion, regardless of the zoning code scheme implemented by a given locality, the zoning verification server 112 may be operative to compare a business type assigned to a business listing with the government zoning information stored in the zoning information database 306. The zoning information mapping database 310 may also maintain different mappings of zoning codes for different localities. Thus, the zoning information mapping database 310 may have a first mapping set for a first locality, a second mapping set for a second locality, and so forth. In this manner, even if the zoning codes used in, for example, Newark, N.J., are different from the zoning codes used in, for example, Trenton, N.J. the zoning verification server 112 may consistently compare zoning codes and business types.

Furthermore, the zoning codes for the various localities may be reduced to a common set of zoning codes such that, regardless of the zoning codes used in a given locality, the zoning verification server 112 leverages the common set of zoning codes rather than the zoning codes for each particular locality. Hence, even if the zoning codes used across various localities vary by name or acronym, the zoning verification server 112 may still determine a common set of zoning codes for a business listing of a given type.

Moreover, the zoning information mapping database 310 enhances the ability of the zoning verification server 112 to account for newly added localities or for changes in previously recorded government zoning information. For example, when a new locality or geographic area is added to the zoning verification server 112, the zoning verification server 112 may create a new mapping based on the government zoning information for the new locality or geographic area. Hence, the zoning information mapping database 310 increases the flexibility of the zoning verification server 112 to support additional localities or to account for modifications in the government zoning information for a given locality.

Using the zoning information mapping database 310, the zoning verification server 112 may determine whether a given business identified in a business listing is of a business type that is expected or permitted at the postal address assigned to the business listing. The zoning verification server 112 may first receive a business listing (or selected business listing attribute values) from the business listing server 104. The zoning verification server 112 may then query the zoning information database 306 to retrieve the relevant government zoning information for a postal address assigned to the business listing. For example, the zoning verification server 112 may query the zoning information database 306 to obtain the relevant zoning codes for the postal address of “1600 Amphitheatre Parkway, Mountain View, Calif.”

In instances where the zoning information mapping database 310 does not contain a zoning code for a given postal address, the zoning verification server 112 may pass on making determinations for the corresponding business listing. In these instances, the zoning verification server 112 may simply ignore the corresponding business listing. Alternatively, the zoning verification server 112 may indicate that no zoning codes were retrievable for the corresponding business listing.

Where a postal address is not directly mapped to a zoning code available in the zoning verification server 112, the server may rely on other portions of the postal address, such as the ZIP code, the city name, or other such identifiers, to retrieve a zoning code for the given business listing. The zoning verification server 112 may also communicate with other systems, such as a geolocation server (not shown), to translate the postal address of the business listing into Global Positioning System (“GPS”) coordinates (e.g., a pair of coordinates that includes a latitude coordinate and a longitude coordinate), and use those coordinates to search for zoning code information.

The zoning verification server 112 may then leverage the zoning information mapping database 310 to identify one or more permitted business types corresponding to the zoning code retrieved from the zoning information database 306. For example, the zoning verification server 112 may query the zoning information mapping database 310 with the retrieved zoning code. The response from the zoning information mapping database 310 may include one or more business types that have been mapped to that zoning code (e.g., that are permitted to be located in an area having that zoning code).

Where a business type has not been previously assigned to a business listing received from the business listing server 104 the zoning verification server 112 may leverage internal or external systems to determine the business type of the business for the provided business listing. For example, where the zoning verification server 112 is provided with a business listing name, the zoning verification server 112 may query an online search provider with the business listing name to determine the business type of the business listing.

The zoning verification server 112 may then compare the one or more business types retrieved from the zoning information mapping database 310 with the assigned (or determined) business type of the given business listing. The zoning verification server 112 may then take one or more actions depending on the outcome of this comparison based on a set of one or more moderation rules 322-324 that are contained in a moderation rules database 312. The moderation rules 322-324 may instruct the zoning verification server 112 how to proceed in view of the comparison between the one or more business types retrieved from the zoning information mapping database 310 and the business type received as part of the business listing from the business listing server 104. For example, one of the moderation rules 322-324 may require the removal of the business listing from the business listing database 208 when there is a clear mismatch between the business type of the business listing and the one or more allowed business types retrieved from the zoning information mapping database 310. However, not all mismatches may result in the removal of the business listing or the identification of the business listing as a potentially false business listing. For example, there may be instances where the business type of the provided business listing is similar to one or more of the permitted business types retrieved from the zoning information mapping database 310. For example, the business type “retailer” may be considered similar to the permitted business type “electronics retailer” or the business type “supermarket” may be considered similar to the permitted business type “convenience store.”

In these instances the zoning verification server 112 may identify or transmit an indication to the business listing server 104 that the provided business listing should be moderated by another entity, such as a human moderator or other verification system. Moderating the business listing may include an examination of the zoning code assigned to the postal address of the provided business listing and the business type of the business listing.

Moderation of a business listing may also be required when the business type of the provided business listing is not mapped to a given zoning code. This may occur, for example, when the business type is stored in the business type database 208 of the business listing server 104, but one or more databases 306-312 of the zoning verification server 112 have not yet been populated with this new business type. In this situation, one or more moderation rules 322-324 may request that the business listing be moderated or that modifications be performed on the zoning verification server 112 to include the business type.

In moderating or reviewing business listings, the business listing server 104 may transmit one or more business listings (or business listing attributes) to the zoning verification server 112 at predetermined times. One predetermined time may be when the business listing is initially established in the business listing server 104 and prior to being made publicly available (e.g., available to a user or an online service provider). At this first predetermined time, the business listing server 104 may transmit the initially established business listing to the zoning verification server 112 to confirm that the business listing is of a type that is permitted to be located at the geographic location corresponding to the postal address of the business listing. Where the zoning verification server 112 determines that the business listing is of a type that is not permitted to be located at the listed postal address, and therefore considers the business listing to be a false business listing or a potentially false business listing, the business listing server 104 may postpone publishing the business listing until the business listing has been moderated.

Another predetermined time period may be at regular intervals, such as monthly, weekly, annually, or at other intervals. During this alternate or second predetermined time period, the business listing server 104 may provide one or more business listings to the zoning verification server 112 that have been modified since the last time they were checked by the zoning verification server 112. In this manner, the business listing server 104 may regularly check whether a given business listing is a potentially false business listing whenever one or more attributes of the business listing have been modified. This type of safeguard may prevent a business listing owner from establishing a business listing with a postal address corresponding to a geographic location having a zoning code appropriate for the type of the business listing to a postal address corresponding to a geographic location having a zoning code inappropriate for the business type for the business listing after an initial approval of the business listing based on the originally provided address.

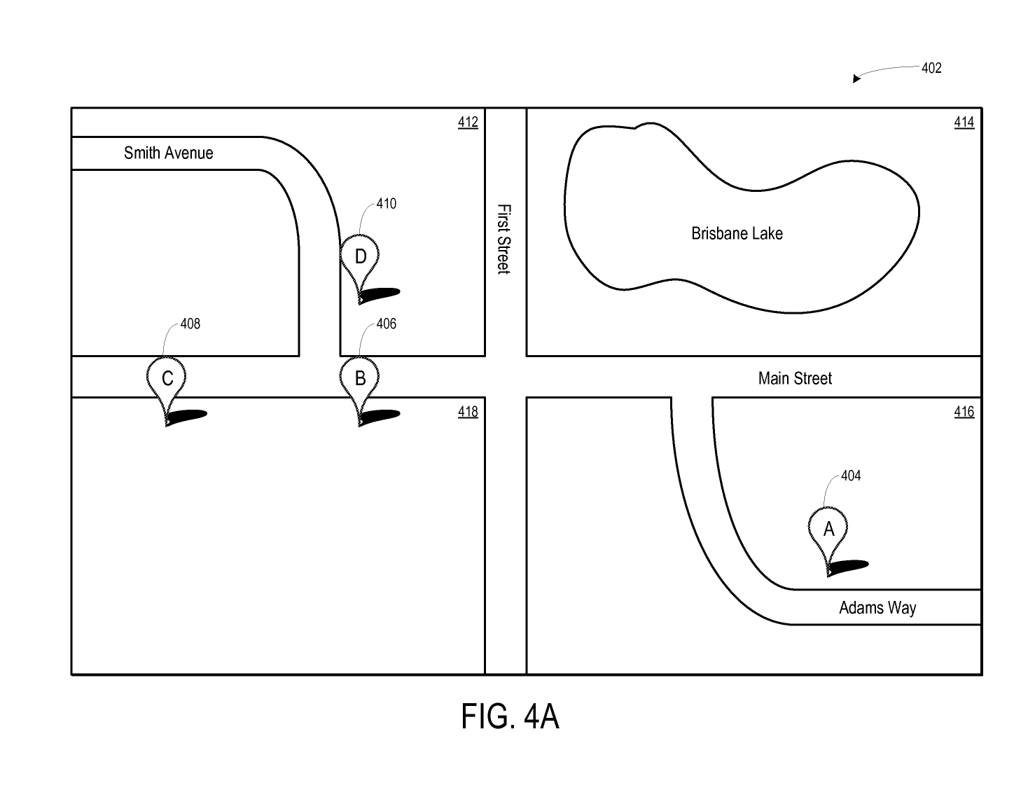

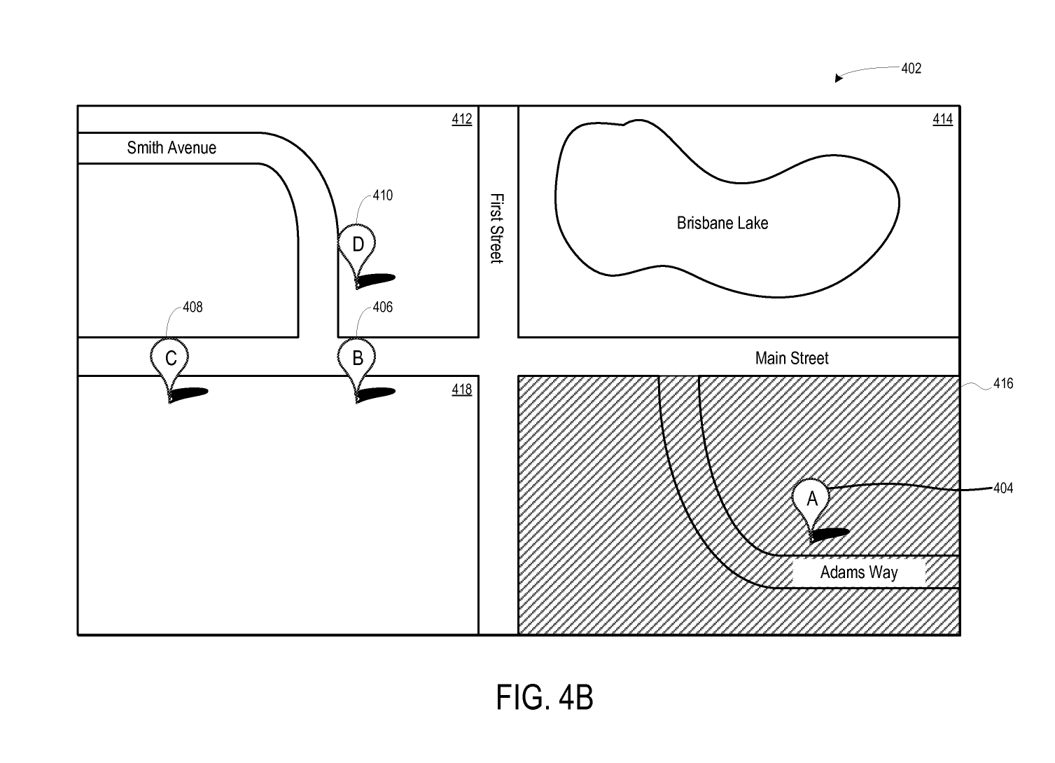

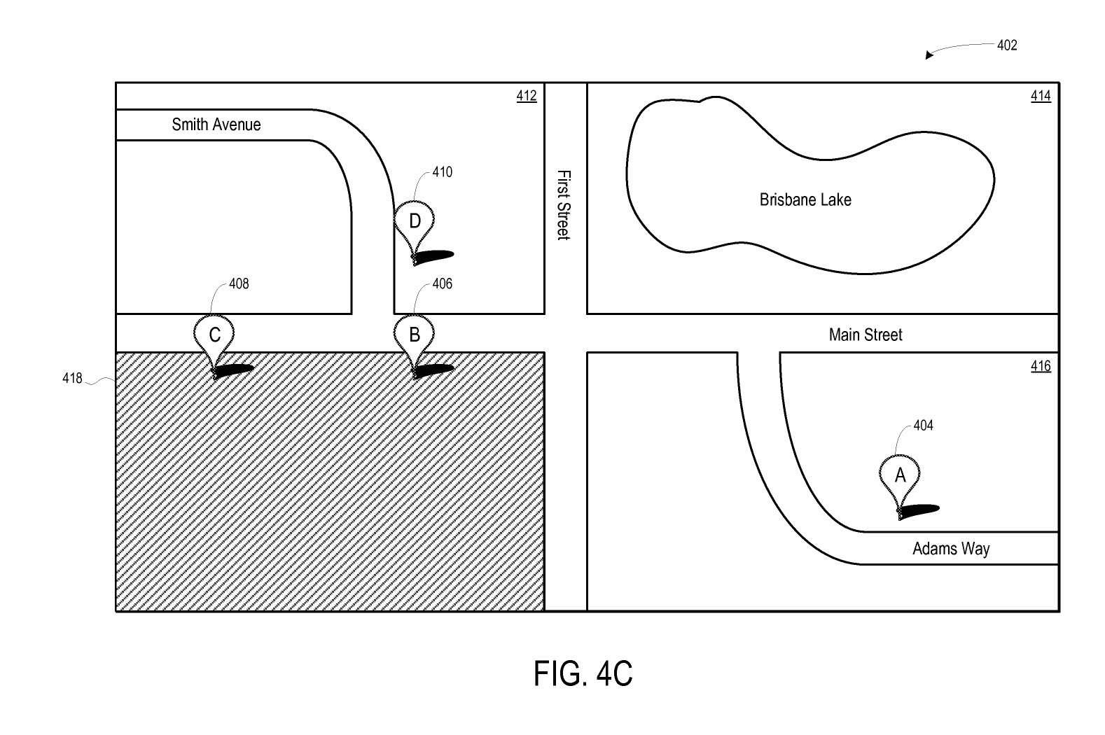

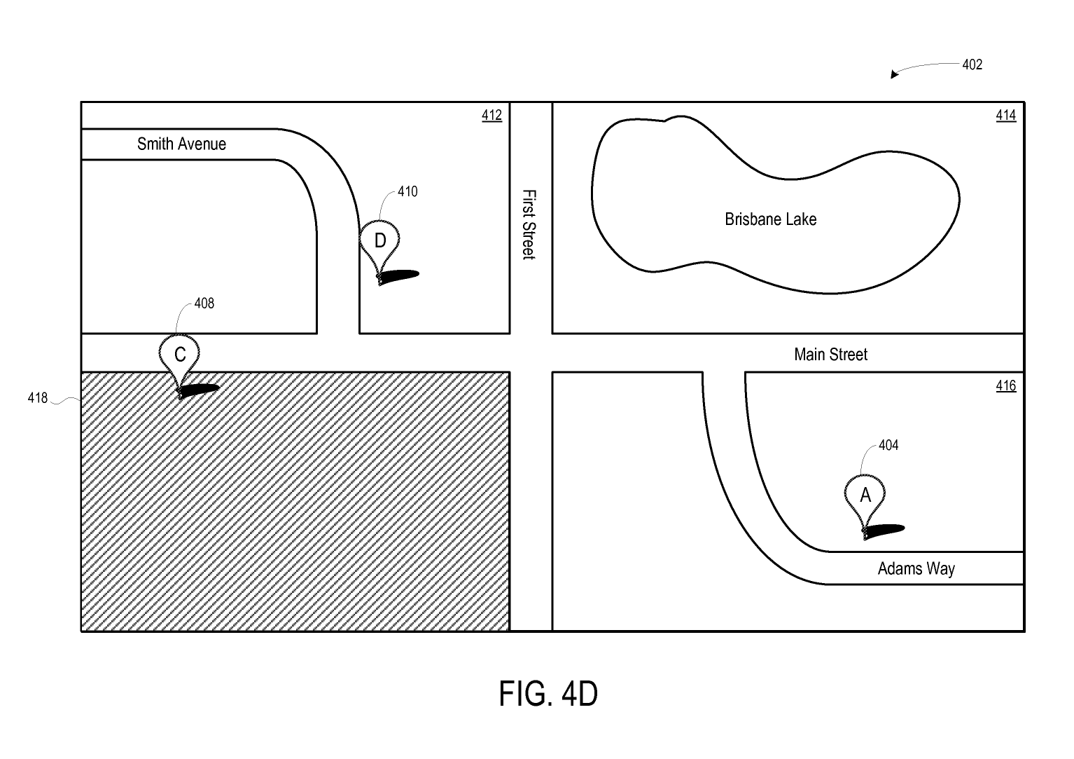

FIGS. 4A-4D illustrate an example process for verifying one or more business listings 404-410 based on government zoning information according to aspects of the disclosure. In FIG. 4A, a larger geographic area 402 has been divided into four smaller geographic areas 412-416. Each of the smaller geographic areas 412-416 may be assigned the same, or different, zoning codes. For the purposes of this disclosure, it is assumed that the four geographic areas 412-416 have been assigned the same zoning code.

FIG. 4B illustrates, pictorially, an example of the zoning verification server 112 comparing the government zoning information of the geographic area 416 with the “A” business listing 404. As mentioned previously, the zoning verification server 112 may receive the business listings 404-410 from the business listing server 104. The zoning verification server 112 may then extract the postal address of the A business listing 404 to determine the zoning code of the geographic area 416 in which the A business listing 404 purports to be located. As mentioned previously, the zoning verification server 112 may cause the processor 304 to query the zoning information database 306 with the extracted postal address to retrieve the corresponding zoning code.

The zoning verification server 112 may then cause the processor 304 to retrieve the business types expected to be in the geographic area 416 by querying the zoning information mapping database 310 with the zoning code retrieved from the zoning information database 306. The zoning verification server 112 may then compare the business type of the A business listing 404 with the one or more business types retrieved from the zoning information mapping database 310, and invoke one or more moderation rules 322-324 based on the comparison. Where the business type of the A business listing 404 is satisfactory (e.g., the A business listing 404 is of a type that is permitted in the zone 416, and therefore does not need to be moderated, removed, or flagged as a potentially false business listing), the zoning verification server 112 may transmit an indication to the business listing server 104 that the A business listing 404 should be made publicly available (if it is not already).

FIGS. 4C-4D illustrate the removal of a business listing when the zoning verification server 112 determines the business listing to have a business type that is an unmistakable mismatch for the zoning code assigned to a geographic area. In FIG. 4C, the zoning verification server 112 may compare the business type of the B business listing 406 with the business types permitted to be located in the geographic area 418. In other words, the zoning verification server 112 may determine whether the B business listing 406 is an appropriate business type given the zoning code assigned to the zoning area 418. Where there is an unmistakable mismatch between the business type of the B business listing 406 and the zoning code of the geographic area 418, the zoning verification server 112 may, pursuant to one or more moderation rules 322-324, remove the B business listing 406 from the business listing database 206 or may indicate to the business listing server 104 that the B business listing 406 should not be made publicly available. Hence, as shown in FIG. 4D, the B business listing 406 will not appear in a published map of the geographic area 402.

Alternatively, where the B business listing 406 has a business type that is neither an unmistakable mismatch requiring removal of the business listing or a satisfactory business type allowing for the publication of the business listing, the zoning verification server 112 may identify the B business listing 406 as a business listing to be moderated. Although the B business listing 406 may be temporarily unavailable to the public during moderation (as shown in FIG. 4D), a moderation that determines that the B business listing 406 is an appropriate type of business given the zoning codes for the geographic area 418 may result in the B business listing 406 becoming publicly available. Thus, the identification of a business listing as a business listing for moderation does not necessarily result in the removal of the business listing. Rather, it raises a flag that the business listing may be a potentially false business listing and should be further investigated.

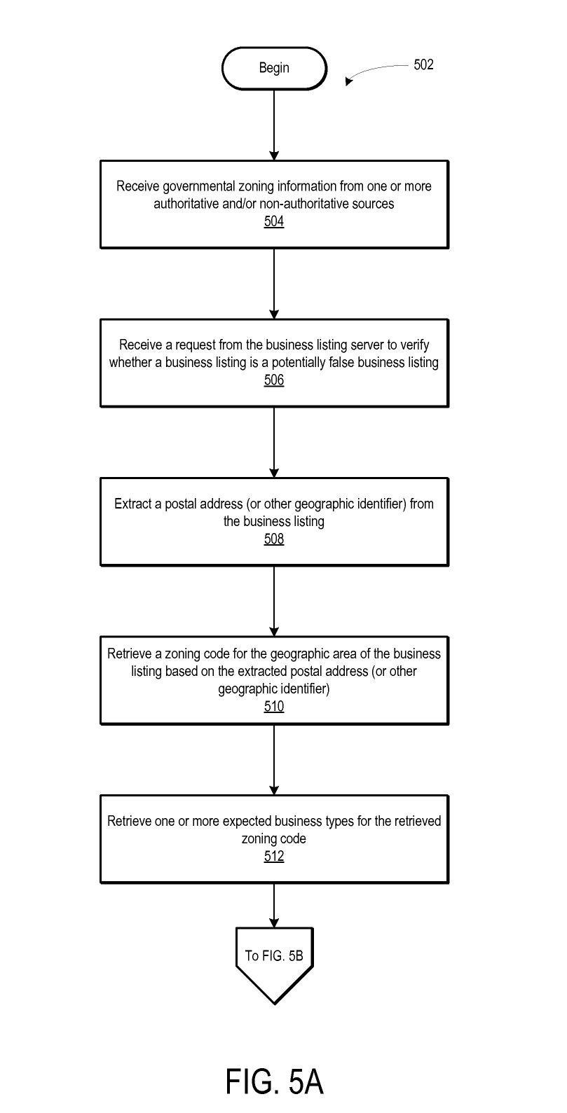

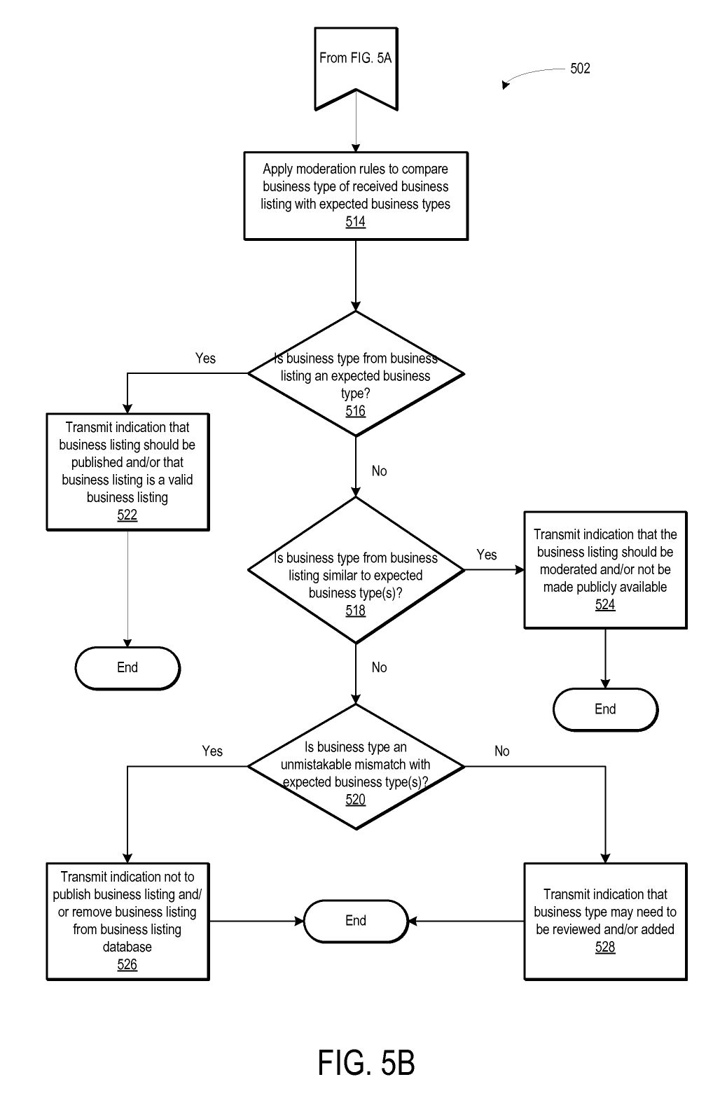

FIGS. 5A-5B illustrate one example of logic flow 502 for detecting potentially false business listings based on government zoning information according to aspects of the disclosure. As mentioned previously, the zoning verification server 112 may initially receive government zoning information from one or more sources 116-120 of government zoning information (Block 504). The zoning verification server 112 may populate the zoning information database 306 with this information.

At some time, whether a predetermined time or a spontaneous time, the zoning verification server 112 may receive a request to identify whether a business listing is a potentially false business listing (Block 506). The zoning verification server 112 may receive the request from a client device and/or system, such as the business listing server 104. The request may include one or more business listing attributes, such as a postal address, a business type, a business name, a URL for the business, or any other such business listing attributes. The request may also include one or more business listings.

The zoning verification server 112 may then extract a postal address from the request (Block 508). Alternatively, or in addition, the zoning verification 112 may determine a set of GPS coordinates for the postal address. As mentioned previously, the zoning verification server 112 may communicate with a geolocation server (not shown) to determine the GPS coordinates that correspond, either exactly or approximately, to the extracted postal address.

The zoning verification server 112 may then retrieve one or more zoning codes from the zoning information database 306 based on the extracted postal address (Block 510). The retrieved one or more zoning codes may be based on the entire postal address, a portion of the postal address, combinations of portions of the postal address, or any other such arrangements of the postal address. Alternatively, or in addition, the processor 304 may retrieve the one or more zoning codes based on the determined GPS coordinates or even based on a combination of the determined GPS and postal address.

The zoning verification server 112 may then determine the business types expected or permitted to be located within the geographic area based on the retrieved one or more zoning codes (Block 512). As mentioned previously, the zoning verification server 112 may retrieve one or more expected or permitted business types from a zoning information mapping database 310 that maps one or more business types to one or more zoning codes. The mappings between business types and zoning codes can be one-to-one, one-to-many, many-to-one, or many-to-many. For example, the business type “supermarket” may be mapped to both a “light commercial” zoning code and a “light residential” zoning code. Other similar mappings and arrangements are also possible.

Continuing to FIG. 5B, the zoning verification server 112 may then apply one or more moderation rules 322-324 based on the comparison between the business type of the business listing and the expected or permitted business types retrieved from the zoning information mapping database 310 (Block 514). One such moderation rule 322-324 is based on whether the business type of the business listing matches an expected or permitted business type given the location of the business listing and the zoning codes in that area (Block 516). When it is, the zoning verification server 112 may transmit a response to the requesting client device (e.g., the business listing server 104) that the business listing to be verified is valid and/or should be made publicly available (Block 522).

Another such moderation rule 322-324 is based on whether the business type of the business listing is similar to one or more of the expected or permitted business types retrieved from the zoning information mapping database 310 (Block 518). When it is, the zoning verification server 112 may transmit a response to the requesting client device that the business listing should be moderated (Block 524). Alternatively, or in addition, the zoning verification server 112 may transmit a response to the requesting client to cause the business listing to not be made publicly available. When a business listing is thus flagged for moderation, it may be subsequently published or made unpublishable based the outcome of the moderation.

A third moderation rule 322-324 is based on whether the business type of the business listing is an unmistakable mismatch with the expected or permitted business types in the zoning area in which the business is purportedly located (Block 520). When it is, the zoning verification server 112 may transmit a response to the business listing server 104 that the business should not be published and/or should be removed from the business listing database 206 (Block 526). Alternatively, or in addition, the zoning verification server 112 may remove the business listing from the business listing database 206.

Finally, a fourth moderation rule 322-324 is based on whether the business type of the business listing is a type that has not previously been mapped to a zoning code in the zoning information mapping database 310. In this situation, the zoning verification server 112 may transmit a response to the requesting client device that the business type itself, rather than the complete business listing, should be moderated (or reviewed) and/or possibly mapped to one or more zoning codes in the zoning information mapping database 310 (Block 528). Thus, business types that the zoning verification server 112 may not have been previously mapped may be flagged for further review.

In this manner, the zoning verification server 112 facilitates an expeditious identification of potentially false business listings prior to the publication of those business listings or at some point after the publication of those business listings. By leveraging the zoning information database 306 and the zoning information mapping database 310, the zoning verification server 112 may review hundreds or thousands of business listings quickly to confirm that the business corresponding to the business listing is at least of a type that is permitted to be located at the location included in the business listing.

Hence, the zoning verification server 112 described above serves as a check that a given business is of the type of business expected or permitted to be found in a geographic area within which the business is purported to be located. When a business listing is of a type that is inconsistent with the zoning codes of the area in which the business is purported to be located, the business listing is marked as a potentially false business listing, and may either be removed from the business listing database 206 or moderated. This helps to ensure that the business listing server 104 provides a more accurate set of business listings to users of the business listing server 104.

The business listing server 104 and/or the zoning verification server 112 described above may be implemented in a single system or partitioned across multiple systems. In addition, the memory 202 and/or the memory 302 may be distributed across many different types of computer-readable media. The memory 202 and/or the memory 302 may include random access memory (“RAM”), read-only memory (“ROM”), hard disks, floppy disks, CD-ROMs, flash memory or other types of computer memory. Moreover, the memory 202 and the memory 302 may be the same memory.

One or more of the databases 206-210 and the databases 306-312 may be implemented in a combination of software and hardware. Similarly, business listing server application 210 may be implemented in a combination of software and hardware. For example, the business listing server application 210 may be implemented in a computer programming language, such as C#, Java, C++ or any other computer programming language now known or later developed. The business listing server application 210 may also be implemented in a computer scripting language, such as JavaScript, PHP, ASP, or any other computer scripting language now known or later developed. Furthermore, the business listing server application 210 may be implemented using a combination of computer programming languages and computer scripting languages.

In addition, the business listing server 104 and/or the zoning verification server 112 may be implemented with additional, different, or fewer components. As one example, the processor 204, the processor 304, and any other logic or component, may be implemented with a microprocessor, a microcontroller, a DSP, an application specific integrated circuit (ASIC), discrete analog or digital circuitry, or a combination of other types of circuits or logic. In addition, the processor 204 and the processor 304 may be the same processor.

One or more of the databases 206-210 of the business listing server 104 and/or one or more of the databases 306-312 of the zoning verification server 112 may be distributed among multiple components, such as among multiple processors and memories, optionally including multiple distributed processing systems.

Logic, such as programs, may be combined or split among multiple programs, distributed across several memories and processors, and may be implemented in or as a function library, such as a dynamic link library (DLL) or other shared library. The DLL, for example, may store code that implements functionality for a specific module as noted above. As another example, the DLL may itself provide all or some of the functionality of the system.

One or more of the databases 206-210 of the business listing server 104 and/or one or more of the databases 306-312 of the zoning verification server 112 may be implemented in any number of arrangements. For instance, although the databases 206-210 of the business listing server 104 and/or the databases 306-312 of the zoning verification server 112 are not limited to any single implementation, one or more of the databases 206-210 of the business listing server 104 and/or one or more of the databases 306-312 of the zoning verification server 112 may be stored in computer registers, as relational databases, flat files, or any other type of database now known or later developed.

The network 110, the network 114, and the network 122 may be implemented as any combination of networks. Moreover, the network 110, the network 114, and the network 122 may be the same network. The network 110, the network 114, and the network 122 may also be various types of networks. As examples, the network 110, the network 114, and/or the network 122 may be a Wide Area Network (“WAN”), such as the Internet; a Local Area Network (“LAN”); a Personal Area Network (“PAN”), or a combination of WANs, LANs, and PANs. Moreover, the network 110, the network 114, and/or the network 122 may involve the use of one or more wired protocols, such as the Simple Object Access Protocol (“SOAP”); wireless protocols, such as 802.11a/b/g/n, Bluetooth, or WiMAX; transport protocols, such as TCP or UDP; an Internet layer protocol, such as IP; application-level protocols, such as HTTP, a combination of any of the aforementioned protocols, or any other type of network protocol now known or later developed.

Interfaces between and within the business listing server 104 and/or the zoning verification server 112 may be implemented using one or more interfaces, such as Web Services, SOAP, or Enterprise Service Bus interfaces. Other examples of interfaces include message passing, such as publish/subscribe messaging, shared memory, and remote procedure calls.

Although aspects of this disclosure have been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of this disclosure as defined by the appended claims. Furthermore, while certain operations and functions are shown in a specific order, they may be performed in a different order unless it is expressly stated otherwise.

1. An apparatus for detecting potentially false business listings, the apparatus comprising:
a processor operative to:
receive business listing information, including information from which a business location and a business type can be determined;
access, from a computer-readable medium, government zoning information pertaining to a zoning area that includes the business location, including information identifying one or more business types that are permitted in the zoning area;
compare the business type of the business listing with the one or more business types that are permitted in the zoning area; and
identify a business listing as a potentially false business listing when the business type of the business listing does not match any of the one or more business types that are permitted in the zoning area.

2. The apparatus of claim 1, wherein the processor is further operative to flag the potentially false business listing so that it is not made publicly available.

3. The apparatus of claim 1, wherein the processor is further operative to remove the potentially false business listing from a data repository containing one or more business listings.

4. The apparatus of claim 1, wherein the processor is further operative to request moderation of the potentially false business listing to confirm whether the potentially false business listing should be made publicly available.

5. The apparatus of claim 1, wherein the processor is further operative to receive the business listing information with a request to verify whether the business listing is a potentially false business listing prior to publication of the business listing.

6. The apparatus of claim 1, wherein the processor is further operative to receive the business listing information with a request to verify whether the business listing is a potentially false business listing after a change has been made to the business listing.

7. A method for detecting potentially false business listings, comprising:
receiving business listing information, including information from which a business location and a business type can be determined;
accessing with a processor, from a computer-readable medium, government zoning information pertaining to a zoning area that includes the business location, including information identifying one or more business types that are permitted in the zoning area;
comparing the business type of the business listing with the one or more business types that are permitted in the zoning area; and
identifying a business listing as a potentially false business listing when the business type of the business listing information does not match any of the one or more business types that are permitted in the zoning area.

8. The method of claim 7, further comprising flagging the potentially false business listing so that it is not made publicly available.

9. The method of claim 7, further comprising removing the potentially false business listing from a data repository containing one or more business listings.

10. The method of claim 7, further comprising requesting moderation of the potentially false business listing to confirm whether the potentially false business listing should be made publicly available.

11. The method of claim 7, wherein the business listing is received with a request to verify whether the business listing is a potentially false business listing prior to publication of the business listing.

12. The method of claim 7, wherein the business listing is received with a request to verify whether the business listing is a potentially false business listing after a change has been made to the business listing.

13. A computer-readable medium having instructions stored thereon that, when executed by a processor, cause the processor to perform a method, the method comprising:
receiving business listing information, including information from which a business location and a business type can be determined;
accessing with the processor, from the computer-readable medium, government zoning information pertaining to a zoning area that includes the business location, including information identifying one or more business types that are permitted in the zoning area;
comparing the business type of the business listing with the one or more business types that are permitted in the zoning area; and
identifying a business listing as a potentially false business listing when the business type of the business listing information does not match any of the one or more business types that are permitted in the zoning area.

14. The computer-readable medium of claim 13, wherein the method further comprises flagging the potentially false business listing so that it is not made publicly available.

15. The computer-readable medium of claim 13, wherein the method further comprises removing the potentially false business listing from a data repository containing one or more business listings.

16. The computer-readable medium of claim 13, wherein the method further comprises requesting moderation of the potentially false business listing to confirm whether the potentially false business listing should be made publicly available.

17. The computer-readable medium of claim 13, wherein the business listing is received with a request to verify whether the business listing is a potentially false business listing prior to publication of the business listing.

18. The computer-readable medium of claim 13, wherein the business listing is received with a request to verify whether the business listing is a potentially false business listing after a change has been made to the business listing.
